(19) United States
(12) Patent Application Publication
(10) Pub. No.: US 2017/0182554 A1
(43) Pub. Date: Jun. 29, 2017

(54) METHOD FOR PRODUCING CERAMIC AND/OR METAL COMPONENTS

(71) Applicant: FRAUNHOFER-GESELLSCHAFT ZUR FOERDERUNG DER ANGEWANDTEN FORSCHUNG E.V., Muenchen (DE)

(72) Inventors: Uwe SCHEITHAUER, Dresden (DE); Eric SCHWARZER, Dresden (DE); Claudia POITZSCH, Dresden (DE); Hans-Juergen RICHTER, Dresden (DE); Tassilo MORITZ, Freiberg (DE); Michael STELTER, Roehrsdorf (DE)

(73) Assignee: FRAUNHOFER-GESELLSCHAFT ZUR FOERDERUNG DER ANGEWANDTEN FORSCHUNG E.V., Muenchen (DE)

(21) Appl. No.: 15/312,864

(22) PCT Filed: May 19, 2015
(86) PCT No.: PCT/EP2015/060968

§ 371 Date: Nov. 21, 2016

(30) Foreign Application Priority Data
May 20, 2014 (DE) 10 2014 209 519.0

(51) Int. Cl. B22F 3/10; B33Y 10/00; B33Y 80/00; B28B 1/00; C04B 35/626; C04B 35/486; C04B 35/111; C04B 35/632; C04B 35/638; C04B 35/64; B22F 3/00; B28B 11/24

(52) U.S. Cl. CPC B22F 3/1021; B22F 3/004; B33Y 10/00; B33Y 80/00; B28B 1/001; B28B 11/243; C04B 35/486; C04B 35/111; C04B 35/632; C04B 35/638; C04B 35/64; C04B 35/6261; B22F 2003/1042; C04B 2235/3225; C04B 2235/3246; C04B 2235/3217; C04B 2235/5436; C04B 2235/602; C04B 2235/6562; C04B 2235/6582; C04B 2235/77

(57) ABSTRACT

The invention relates to a method of manufacturing ceramic and/or metallic components in which a support structure surrounding at least one free space is formed using a polymer and in which at least one free space is filled in at least one predefinable portion with a plastically deformable or liquid mixture of least one metal powder or ceramic powder and at least one organic binder. In this respect, the mixture contacts the wall of the structure at least in part. Subsequently, in a first thermal treatment, the mixture is transformed into a state having a sufficient strength for maintaining its geometrical shape and a temperature is observed in so doing at which the polymer forming the support structure remains stable in shape. Subsequently, in a second thermal treatment, the temperature is increased and in so doing the polymer forming the support structure is completely decomposed and the metal powder and/or ceramic powder is/are sintered.

The invention relates to a method of manufacturing ceramic and/or metallic components. Pure ceramic, pure metallic or composite components in which portions are formed from metal and other portions are formed from ceramics can thus be manufactured. There is additionally the possibility of forming portions of components from different metals or ceramics. The components are in this respect manufactured by sintering powdery materials.

Various possibilities are known for the manufacture of at least similar components. Components can thus be brought into the desired form by injection molding processes in molding tools. The molding tools required for this purpose are cost-intensive so that a use is only amortized with larger volumes.

With selective laser sintering, only a limited density can be achieved in components manufactured in this manner.

Additive processes are suitable for a highly flexible production of single parts and small production runs due to the lack of tool costs and the high exploitation of the material. However, the previously known additive processes are limited with respect to the achievable surface quality, the portfolio of processable materials or with respect to the suitability for forming cavities or other inner structures in components to be manufactured in this manner.

It is therefore the object of the invention to provide possibilities for a flexible manufacture of components made of ceramics and/or of metal in different geometries with which a high density and good surface quality can be achieved at the outer surface and at the inner surface.

In accordance with the invention, this object is achieved by a method having the features of claim 1. Advantageous embodiments and further developments of the invention can be realized using features designated in subordinate claims.

In the method in accordance with the invention of manufacturing ceramic and/or metal components, a support structure is formed which surrounds at least one free space using a polymer or a polymer mixture. The at least one free space is filled in at least one predefinable portion with a plastically deformable or liquid mixture of at least one metal powder or ceramic powder and at least one organic binder so that the mixture contacts the wall of the support structure at least in part. A mixture of metal powder and ceramic powder can also be used.

Subsequently, in a first thermal treatment, the mixture is transformed into a state having a sufficient strength, even on a further temperature increase, to maintain its geometrical shape. A temperature is observed in this respect at which the polymer forming the support structure remains stable in shape.

Subsequent thereto, in a second thermal treatment, the temperature is in turn increased and the polymer forming the support structure as well as the remaining binder components of the mixture are in so doing decomposed and the metal powder and/or ceramic powder is/are sintered.

The support structure can be formed by an areal or selective application of the non-hardened viscous polymer onto the surface of a carrier. On an areal application, a locally defined hardening of the polymer can subsequently take place by a locally defined input of energy or material and subsequent thereto any non-hardened polymer can in turn be removed. A solvent can be used for this purpose, for example. Alternatively, polymer not required for the support structure can be washed out, blown off or sucked off.

The application of the polymer/polymer mixture for the support structure can take place by spreading on, rolling on, dispensing or printing, which should preferably be achieved in a metered form.

On a selective application, the polymer can only be applied in portions in which a support structure is to be formed and can be hardened there. A selective locally defined application can take place by spraying or by means of a dispenser only in portions in which a support structure is to be formed.

The polymer can be hardened by locally defined irradiation with electromagnetic radiation. A laser beam or a mask which is arranged between a radiation source and the polymer or another selective radiation source by which a spot-shaped or linear or spatially resolved irradiation is possible can be used for this purpose, for example. A locally defined material input, for example of a hardener or of a cross-linking agent, is also possible.

The support structure can be formed by a layer-wise application in a plurality of planes arranged above one another. A support structure formed in this manner can have different geometrical shapes in planes. Channels, undercuts or even cavities can thereby be formed in the later component. The support structure can also have cavities buried in it since the quantity of material to be removed and the debinding gases becoming free can thereby be reduced.

On a layer-wise formation of a support structure, at least one mixture can be filled into at least one formed free space successively following the layer-wise formation of the support structure and likewise in a layer-wise manner. Very fine channels/portions within the support structure into which the mixture would not reach due to its poor flow properties on long flow paths can thereby be filled with the mixture.

On a respective alternating formation of layers for a support structure and layers which are formed with the mixture, a free space can be filled while taking account of short flow paths. In this respect, even very small cavities can be filled and minimal geometries can thus be implemented.

It can be sensible with larger free spaces having almost constant geometries first to form a plurality of layers of the support structure and then to fill the total free space at once to reduce the required time for the manufacture.

There is the possibility that at least two mixtures having mutually different consistencies/compositions are poured into a free space within a support structure. Components can thereby be obtained which can comprise the corresponding powder materials used for the mixtures. An outer skin or a surface region of a component can thus, for example, be formed from a material which has different properties than a material in the core of a component.

A plurality of different mixtures can be poured into a free space next to one another and/or above one another.

With a support structure formed successively in a plurality of planes, at least one mixture can be poured into free spaces which are newly formed in this process, which are likewise formed successively in a plurality of planes on the build-up of the support structure and which can in so doing have different geometrical shapes, dimensions and positions.

If a plurality of mixtures are poured into a free space together, an auxiliary polymer can be used in this process to set the desired geometries exactly for the two portions. For this purpose, a further support structure is first prepared in the free space in the support structure using the auxiliary polymer and reduces the free space to the portion into which the first mixture is to be poured. After it has been poured in, the auxiliary polymer can be removed and the portion remains free which can subsequently be filled with the second mixture. This procedure can also be correspondingly adapted for more than two mixtures which are to be filled into a free space. The auxiliary polymer should in this respect be easy to remove again, which can be achieved by a use of suitable solvents and dissolution.

With other mixtures which have been filled into a free space, the shrinkage of the powder materials used can be taken into account. It can be selected as at least approximately of the same size.

To improve the flow capability/lowering of the viscosity and to increase the density of the mixture(s), a shaking or an input of ultrasound waves can be used, for example, as long as a plastic deformability/flow is still present. In this respect, the shear-viscous behavior of the usable mixtures can be utilized.

The usable polymers for the support structure should have a decomposition temperature of at least 250° C., preferably of at least 270° C., and particularly preferably of at least 300° C. A sufficient shape stability can thereby be achieved until the mixture(s) to be subsequently sintered have achieved a sufficient strength and a support is no longer required to maintain the desired shape. The polymer should not be plastically deformable at least up to close to this temperature range. A demand which should be satisfied where possible is a residue-free removability of the polymer.

A polymer or polymer mixture should be used for the formation of the support structure in which at least some is only decomposed after reaching the maximum temperature in the first thermal treatment. A sufficient strength can thereby be maintained until the mixture with which the actual component is formed has a sufficient strength and the function of the support structure no longer has to be satisfied. In addition, the decomposition can thus take place more gently since only a respective portion of the polymer or of the polymer mixture is decomposed and thus a smaller quantity of formed gases is released per time unit.

In addition, a mutual influencing of the polymer and the used at least one organic binder which is a component of the mixture should be avoided.

Bisphenol A-glycerolate dimethacrylates (BisGMA), tri(ethylene glycol) dimethacrylates (TEGDMA), camphorquinones or ethyl 4 (diethylalmino) benzoates can, for example, respectively be used alone or in a mixture of at least two of these polymers as the polymer. Alternatively, polyvinyl alcohol, acrylic latex or other polymer dispersions can respectively also be used alone or also in a mixture thereof to prepare the support structure. The viscosity of the polymer used suitable for the formation of the support structure can be set using a solvent for the respective polymer.

Beeswax, paraffin or pyrrolidones or a mixture of them can, for example, be used as organic binders for the mixtures.

The mixtures which can be used should have solid proportions of at least 40%. The powders used should have particle sizes d₅₀ which are as small as possible and which should be less than 15 μm for metals and less than 5 μm for ceramics. The mixtures which can be used in the invention can also be called 3DTP compounds.

A mixture containing ceramic particles and/or metal particles and containing an organic binder should advantageously be used that is plastically deformable at normal environmental temperature or at the processing temperature. It can have a reduced viscosity or even be liquid at higher temperatures. The environmental temperature or processing temperature can be selected in the range 20° C.±10° C. and a processing temperature can preferably be selected in the range 80° C.±40° C.

A reduction in the viscosity can also be achieved on acting shear forces.

Sintered components having a very high density and surface quality, in combination with a plurality of materials, can be manufactured very flexibly in different geometrical shapes, also with cavities. A number of disadvantages of the prior art can thus be avoided.

The invention will be explained in more detail in the following with reference to examples.

### EXAMPLE 1

For the manufacture of a component made of stainless steel 17-4 PH, a powder having a mean particle size d₅₀ of 12.2 μm can be homogenized with a mixture of paraffin and beeswax with a solid portion of 47 v/v % in a dissolver over 2 hours. Subsequently, this mixture was poured into the free space of a frame-like support structure at a temperature of 100° C. The frame-like support structure was hardened in advance from BisGMA by a layer-wise application and a successive locally defined irradiation with electromagnetic radiation in the individual applied layers. Excess polymer was removed using a suction apparatus. This removal can take place by washing out by solvent, e.g. ethanol.

In this respect, the mixture formed with the metal powder and the binder mixture can also be poured successfully layer-wise into the free space being correspondingly enlarged by the layer-wise formation of the support structure.

After the pouring in of the mixture that completely filled up the free space within the frame-like support structure and after the obtaining of the green compact having a sufficient strength, a first thermal treatment at air took place in which the first organic binder portions were removed so that the mixture subsequently no longer exhibited any thermoplastic behavior. A heating rate of 18 K/h up to a temperature of 270° C. was observed in this process. The mixture contained in the free space had reached a sufficient shape stability in this respect.

Subsequently thereto, in a second thermal treatment, the temperature was increased to a maximum of 1350° C. while observing a heating rate of 4 K/min and the metal powder was sintered. The thermal decomposition of the polymer forming the frame-like support structure took place at the start of this second thermal treatment. Heating took place at a heating rate of 15 K/h up to a temperature of 800° C. since the residual organic components contained in the mixture have been removed in this temperature range.

The second thermal treatment was carried out in an argon/hydrogen atmosphere.

The component thus obtained from steel material had a density corresponding to 99.3% of the theoretical density.

### EXAMPLE 2

For the manufacture of a component of yttrium-stabilized zirconia (YSZ) with 3 mol % Y₂O₃, a corresponding powder of this material having a mean particle size d₅₀ of 0.3 μm at a solid portion of 45 v/v % was homogenized with a mixture of paraffin and beeswax in a ball mill over 72 h.

This mixture was poured into the free space of a frame-like support structure such as was also used in Example 1.

The two thermal treatments were carried out under the same conditions as in Example 1. On a possible sintering of this ceramic material, the argon/hydrogen atmosphere can, however, be dispensed with; both thermal treatments took place at air. In this case, however, the maximum temperature is to be increased to 1500° C. in the second thermal treatment.

The component thus obtained from YSZ had a density corresponding to 99.9% of the theoretical density.

### EXAMPLE 3

For the manufacture of a component of Al₂O₃, a corresponding powder of this material having a mean particle size d₅₀ of 1.7 μm at a solid portion of 67 v/v % was homogenized with a mixture of paraffin and beeswax in a ball mill over 72 h.

This mixture was poured into the free space of a frame-like support structure such as was also used in Example 1.

The two thermal treatments were carried out under the same conditions as in Example 2. A maximum temperature of 1600° C. was observed in the sintering at air in the second thermal treatment.

The component thus obtained from aluminum oxide had a density corresponding to 99.2% of the theoretical density.

1. A method of manufacturing ceramic and/or metal components in which a support structure surrounding at least one free space is formed by a polymer and in which at least one free space is filled in at least one predefinable portion with a plastically deformable or liquid mixture of at least a metal powder or ceramic powder and with at least one organic binder such that the mixture contacts the wall of the support structure at least in part; and
subsequently, in a first thermal treatment, the mixture is transferred into a state having a sufficient strength for maintaining its geometrical shape and thereby a temperature is observed at which the polymer forming the support structure remains stable in shape; and
subsequently, in a second thermal treatment, the temperature is increased and in so doing the polymer forming the support structure is completely decomposed and the metal powder and/or ceramic powder is/are sintered.

2. A method in accordance with claim 1, characterize in that the support structure is formed by an areal or selective application of the non-hardened viscous polymer or polymer mixture onto the surface of a carrier and subsequently, on an areal application, a locally defined hardening of the polymer takes place by a locally defined energy input or material input and, subsequently, non-hardened polymer is removed; and
on a selective application, the polymer is only applied in portions in which a support structure is to be formed and will be hardened there.

3. A method in accordance with claim 1, characterized in that the support structure is formed by layer-wise application in a plurality of planes arranged above one another.

4. A method in accordance with claim 3, characterized in that at least one mixture is filled successively into at least one formed free space successively following the layer-wise formation of the support structure and likewise in a layer-wise manner before the next layer of the support structure is formed.

5. A method in accordance with claim 1, characterized in that a support structure is formed which has different geometrical shapes in planes.

6. A method in accordance with claim 1, characterized in that an areal application takes place for the formation of a support structure by spreading, rolling, printing or dispensing, preferably in a metered form, and at least the region in which a support structure is to be formed is hardened by locally defined irradiation with electromagnetic radiation or a selectively locally defined application takes place by spraying or by means of a dispenser only in portions in which a support structure is to be formed.

7. A method in accordance with claim 1, characterized in that at least two mixtures having mutually different consistencies/compositions are filled into a free space within a support structure.

8. A method in accordance with claim 7, characterized in that at least two mixtures are filled in arranged next to one another and/or above one another.

9. A method in accordance with claim 1, characterized in that, with a support structure formed successively in a plurality of planes, at least one mixture is filled into free spaces which are newly formed in this process.

10. A method in accordance with claim 1, characterized in that a mixture containing ceramic and/or metal particles and an organic binder is used that is plastically deformable or flowable at normal ambient temperature or at the processing temperature.

11. A method in accordance with claim 1, characterized in that a polymer or polymer mixture is used for the formation of the support structure in which at least a portion is only decomposed after reaching the maximum temperature in the first thermal treatment.
